(19) United States
(12) Patent Application Publication
(10) Pub. No.: US 2009/0122811 A1
(43) Pub. Date: May 14, 2009

(54) METHOD AND APPARATUS FOR MODIFYING BANDWIDTH IN BANDWIDTH ON DEMAND SERVICES

(76) Inventor: Zhiping Wu, Shenzhen (CN)

Correspondence Address: BRINKS HOFER GILSON & LIONE, P.O. BOX 10395, CHICAGO, IL, 60610, US

(21) Appl. No.: 12/354,301

(22) Filed: Jan. 15, 2009

Related U.S. Application Data
(63) Continuation of application No. PCT/CN2007/003350, filed on Nov. 27, 2007.

(30) Foreign Application Priority Data
Dec. 21, 2006 (CN) 200610170248.8

(51) Int. Cl. H04L 29/08

(52) U.S. Cl. 370/468

(57) ABSTRACT

A method for modifying bandwidth in a Bandwidth on Demand (BoD) service includes: a User Network Interface (UNI) client (UNI-C) sends the BoD service based bandwidth modification message to a UNI network (UNI-N) via control plane signaling, the bandwidth modification message carrying a bandwidth modification value; the UNI-N modifies bandwidth according to the bandwidth modification amount and a lower layer tunnel granularity. An apparatus for modifying bandwidth in a BoD service is also disclosed. According to the present invention, by adopting Generalized Multi-Protocol Label Switching (GMPLS) on the control plane and Link Capacity Adjustment Scheme (LCAS), Virtual Concatenation (VC) and Generic Framing Procedure (GFP) on the transport plane, the BoD service can be automatically set up and a client is able to modify service bandwidth according to changes of service traffic dynamically in real time.

This application is a continuation application of, and claims priority to, PCT/CN2007/003350, filed on Nov. 27, 2007, which claims priority to Chinese Patent Application No. 200610170248.8, filed on Dec. 21, 2006 each of which are hereby incorporated by reference herein in their entirety.

### FIELD OF THE INVENTION

The present invention relates a network communication technology, and in particular, to a method and apparatus for modifying bandwidth in a Bandwidth on Demand (BoD) service.

### BACKGROUND OF THE INVENTION

Traditionally, optical transport networks, including Synchronous Digital Hierarchy (SDH), Synchronous Optical Network (SONET) and Optical Transmission Network (OTN) are designed to transport voice services. However, the rapid growth of data services makes data traffic take a higher and higher proportion in the total traffic that optical networks transport. To meet this trend of rapid growth, the Multi-Service Transport Platform (MSTP) emerges, which can access not only traditional voice services but also data services. The MSTP adapts data services at all rates to SDH transport channels via Generic Framing Procedure (GFP), Link Capacity Adjustment Scheme (LCAS) and Virtual Concatenation (VC) technologies. Also, to meet the needs for higher data transport network bandwidth and shorter service provisioning time, network topologies need to evolve from traditional ring networks to grid networks and network connections need to migrate from static permanent connections to signaling-based soft permanent connections and switched connections. The new optical transport network is called Automatically Switched Optical Network (ASON), which adopts a control plane to set up, modify and maintain network connections and restore connections in the event of network failure. One signaling implementation mode of ASON is Generalized Multi-Protocol Label Switching (GMPLS).

In ASON networks, there are more and more data applications, which embody burst and unpredictability characteristics. The traditional SDH networks are designed for circuit services and not adapted to the features of data services. To implement data services, in the existing ASON networks, Ethernet services are set up by means of Soft Permanent Connection (SPC). Before an Ethernet service is set up, the network management system configures a Virtual Concatenation Group (VCG) statically and maps the Ethernet port of the Ethernet card to the corresponding VCG Upon reception of an Ethernet service setup request, the network management system first initiates an SPC setup procedure to set up an SDH channel between the source and destination nodes of the Ethernet service according to the bandwidth required by the Ethernet services. Then the network management system adds a Virtual Container (VC) in the established SDH channel into the corresponding VCG. In this way, an SPC based Ethernet service is set up.

However, in the above Ethernet service, the SDH channel is initiated by the network management system and set up by the control plane, and Ethernet client layer connections are entirely configured by the network management system. The control plane has no client layer service information and the entire procedure is mainly controlled by the network management system. Setting up Ethernet services in the Switched Connection (SC) mode is not supported. Modification of service bandwidth cannot be implemented via the User Network Interface (UNI), in other words, a client cannot initiate bandwidth modification according to the change of service traffic.

### SUMMARY OF THE INVENTION

Embodiments of the present invention provide a method and apparatus for modifying bandwidth in a Bandwidth on Demand (BoD) service so as to modify bandwidth according to changes of service traffic.

A method for modifying bandwidth in a Bandwidth on Demand (BoD) service includes:
receiving, by a User Network Interface (UNI) network (UNI-N), the BoD service based bandwidth modification message from a UNI client (UNI-C) via control plane signaling, the bandwidth modification message carrying a bandwidth modification value; and
modifying, by the UNI-N, bandwidth according to the bandwidth modification value and a lower layer tunnel granularity.

An apparatus for modifying bandwidth in a Bandwidth on Demand (BoD) service, located in a User Network Interface (UNI) network (UNI-N), includes a receiving unit and an modifying unit, where:
the receiving unit is adapted to receive the BoD service based bandwidth modification message from a UNI client (UNI-C) via control plane signaling, the bandwidth modification message carrying a bandwidth modification value; and
the modifying unit is adapted to modify bandwidth according to the bandwidth modification value and a lower layer tunnel granularity.

According to embodiments of the invention, a BoD service can be set up automatically and the service bandwidth can be modified according to changes of the service traffic and the lower layer tunnel granularity.

### BRIEF DESCRIPTION OF THE DRAWINGS

The accompanying drawings are provided herein to facilitate understanding of the present invention and constitute a part of the application without limiting the present invention. In the accompanying drawings:

FIG. 1 shows a signaling procedure where a BoD service is set up according to an embodiment of the present invention;

FIG. 2 shows a procedure where the source UNI-N modifies bandwidth according to an embodiment of the present invention;

FIG. 3 shows a signaling procedure where bandwidth is modified in a BoD service according to an embodiment of the present invention; and

FIG. 4 shows the structure of an apparatus for modifying bandwidth in a BoD service according to an embodiment of the present invention.

### DETAILED DESCRIPTION OF THE EMBODIMENTS

To help those skilled in the art understand and implement the present invention, the following describes embodiments of the invention with reference to the accompanying drawings. Here, the exemplary embodiments of the invention and related descriptions are for explanation of the present invention only, instead of limiting the present invention.

In ASON networks, there are more and more data applications, which embody burst and unpredictability characteristics. The traditional SDH networks are designed for circuit services and not adapted to the features of data services. This imposes a new requirement on the ASON networks, that is, the ASON networks are required to modify network connection bandwidths dynamically in real time according to client service traffic. The new service is called Bandwidth on Demand (BoD).

To realize the BoD service, the Generic Framing Procedure (GFP) technology may be first adopted to map data service signals to SDH frame formats so as to implement the generic framing procedure for all types of services accessed to an optical network. Secondly, because SDH channel capacity is discrete while accessed data services are continuous in rate and embody burst characteristics, to provide a flexible mode to organize channel capacity in a transport network so as to better meet the characteristics of data transport, the virtual concatenation technology may be adopted to combine multiple virtual containers (VCs) as one container that keeps the bit sequence integrity to transport all types of granular services. In addition, the Link Capacity Adjustment Scheme (LCAS) technology may be adopted to change the channel capacity in a Virtual Concatenation Group (VCG) so as to increase or decrease the number of VC members for a service without affecting the established services and further realize the dynamic and non-disruptive modification of service bandwidths. The above three key technologies, GFP, VC and LCAS, together with the Generalized Multi-Protocol Label Switching (GMPLS) protocol stack on the control plane of an ASON network, can set up and delete BoD services and achieve non-disruptive bandwidth modification.

A BoD service procedure in embodiments of the invention may be implemented in two steps: firstly, a client sets up a BoD service via the User Network Interface (UNI) on the control plane; secondly, bandwidths are modified in a non-disruptive manner.

A BoD service setup procedure may also include two steps. The first step is to set up lower layer tunnels within the network for client services. For example, the lower layer tunnel is presented as a high-order VC tunnel or a high-order VC concatenation tunnel. The number of tunnels depends on the bandwidth of the client service and may be one or more. The bandwidth granularity of each tunnel is a high-order VC (VC4) or a high-order VC concatenation. Also, one VCG is set for every client service and to guarantee non-disruptive services during bandwidth modification, the LCAS function of VCGs needs be enabled. The second step is to initiate the setup of a client layer service which takes the lower layer tunnel as the service layer after the lower layer tunnel is successfully set up, and configure the client service in the source and destination node of the tunnel with a low-order VC (VC12) granularity. A BoD service established in this way takes a high-order VC as a tunnel within the network without consuming low-order cross-connect resources and also guarantees that the client service has a low-order VC as the minimum granularity, and bandwidth can be modified in the granularity of a low-order VC.

A BoD service modification procedure first determines whether to add or delete related high-order VC tunnels according to the new bandwidth requirement, and then modifies the number of low-order VCs in the client service VCG to meet the actual requirement for bandwidth. In the modification procedure, because of the assurance of LCAS, the service will not suffer transient interruption.

The following describes a BoD service setup procedure in an Ethernet according to an embodiment of the present invention.

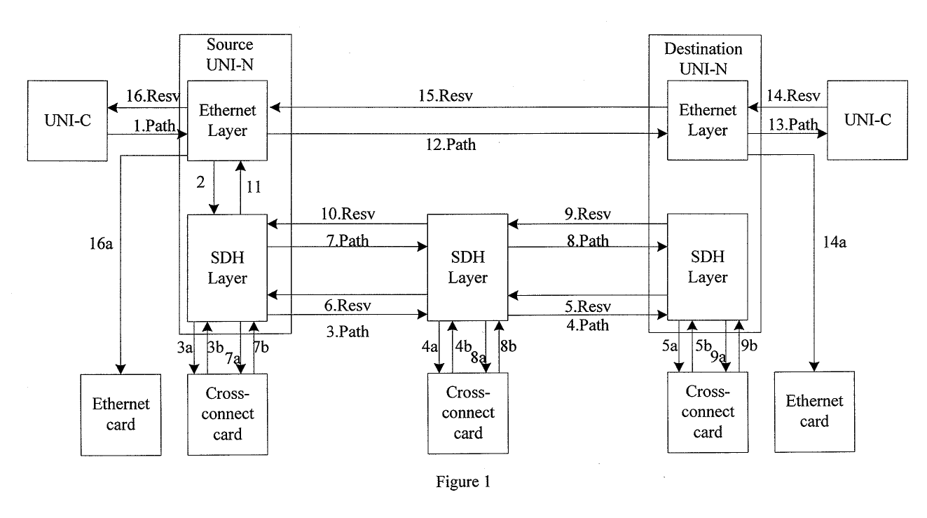

In the BoD service setup procedure, the LCAS function is first enabled for the Ethernet card that requires BoD so as to guarantee non-disruptive services during bandwidth modification. Then, a VCG is assigned to every client service of the Ethernet card. FIG. 1 shows a signaling procedure where a BoD service is set up according to an embodiment of the present invention. As shown in FIG. 1, a BoD service setup procedure includes the following steps.

Step 1: A UNI client (UNI-C) initiates a BoD service request according to the bandwidth requirement of the current client service and sends an Ethernet service setup signaling message (RSVP Path signaling) to the source UNI network (UNI-N) via the control plane.

Step 2: Upon reception of the Ethernet service request via the UNI interface, the source UNI-N drives the setup of a service layer SDH VC4 tunnel via the control plane.

Steps 3-10: One or more VC4 tunnels are set up according to the bandwidth required by the client services. For example, if the client service requires 100 Mbps, one VC4 tunnel is needed; if the client service requires 300 Mbps, two VC4 tunnels are needed. The signaling procedure shown by 3, 4, 5, 6, 7, 8, 9 and 10 in FIG. 1 is a procedure for setting up two VC4 tunnels. Specifically, a lower layer tunnel is set up in steps 3, 4, 5 and 6 and then a second lower layer tunnel is set up in steps 7, 8, 9 and 10. The procedure shown in FIG. 1 may also set up multiple VC4 tunnels (not shown in the figure). During the process of setting up a VC4 tunnel, high-order cross-connect resources are configured at the source and destination nodes and intermediate nodes of the tunnel. The signaling procedure indicated by 3a, 3b, 7a, 7b, 4a, 4b, 8a, 8b, 5a, 5b, 9a, and 9b is the procedure for configuring high-order cross-connect resources.

Step 11: A success reply is returned to the client layer after the lower layer tunnels are set up successfully.

Steps 12-16: The source UNI-N initiates a client layer Ethernet service setup request. The client layer Ethernet service takes the lower layer SDH channel as the service layer and its signaling passes through only the source and destination nodes of the tunnel. A VCG configuration command is sent to the Ethernet card from the source and destination nodes of the service so as to configure the appropriate VC12 tunnels to the VCG according to the client service bandwidth. For example, if the client service bandwidth is 100 Mbps, 50 VC12 tunnels should be configured in the VCG; if the client service bandwidth is 300 Mbps, 150 VC12 tunnels should be configured in the VCG, as shown in steps 16a and 14a in FIG. 1.

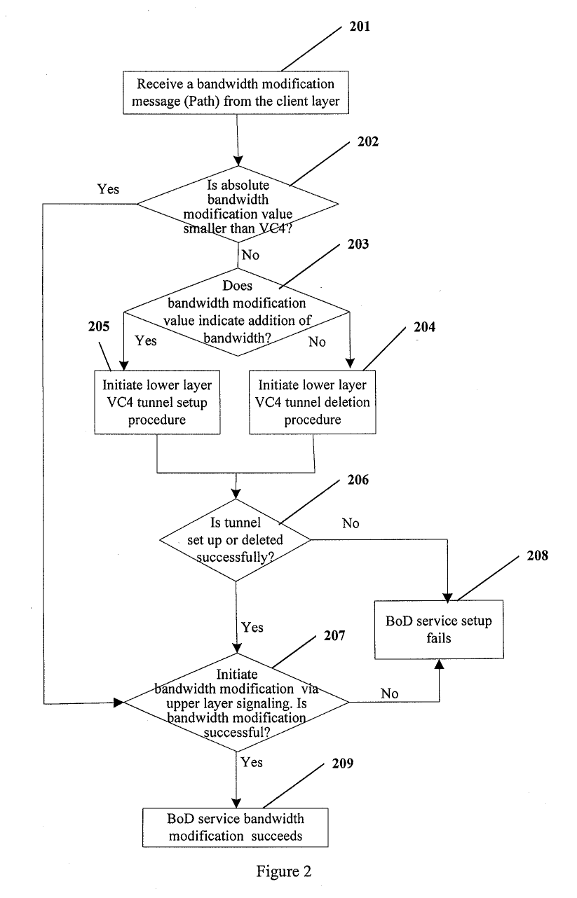

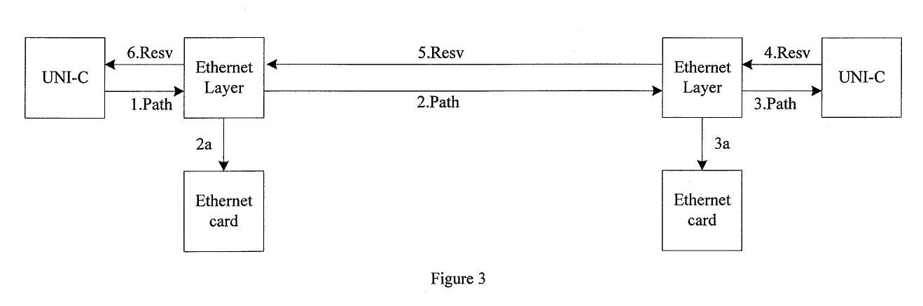

The following describes procedures where bandwidth is modified in a BoD service in an Ethernet according to embodiments of the present invention with reference to FIG. 2 and FIG. 3. FIG. 2 shows a procedure where the source UNI-N modifies bandwidth according to an embodiment of the present invention. FIG. 3 shows a signaling procedure where bandwidth is modified in a BoD service according to an embodiment of the present invention.

Step 201: The source UNI-N receives a bandwidth modification request (like the Path message in signaling procedure 1 shown in FIG. 3) from a UNI-C via the control plane. The bandwidth modification request carries a bandwidth modification value.

Step 202: Upon reception of the service modification request, the source UNI-N judges whether the absolute bandwidth modification value is smaller than a VC4 granularity. If the absolute bandwidth modification value is smaller than a VC4 granularity, the process proceeds to Step 207; otherwise, the process proceeds to Step 203.

Step 203: If the absolute bandwidth modification value is larger than or equal to a VC4 granularity, the source UNI-N determines whether the bandwidth modification value indicates addition of bandwidth, and if so, the process proceeds to Step 205; otherwise, the process proceeds to Step 204.

Step 204: If the bandwidth modification value indicates reduction of bandwidth, the source UNI-N initiates that a lower layer VC4 tunnel deletion procedure and deletes one or more tunnels as indicated by the bandwidth modification value so that the total bandwidth of tunnels meets the modified bandwidth requirement of the BoD service, and that the waste of tunnel bandwidth resources is reduced. For example, if the bandwidth modification value indicates reduction of one VC4, one VC4 tunnel is deleted; if the bandwidth modification value indicates reduction of two VC4 tunnels, two VCs tunnels are deleted. Afterwards, the source UNI-N returns a tunnel deletion success/failure message and the process proceeds to Step 206.

Step 205: If the bandwidth modification value indicates addition of bandwidth, the source UNI-N initiates a lower layer VC4 tunnel setup procedure and sets up one or more tunnels as indicated by the bandwidth modification value so that the total bandwidth of tunnels meets the modified bandwidth requirement of the BoD service. For example, if the bandwidth modification value indicates addition of one VC4, one VC4 tunnel is set up; if the bandwidth modification value indicates addition of two VC4 tunnels, two VCs tunnels are set up. Afterwards, the source UNI-N returns a tunnel setup success/failure message and the process proceeds to Step 206.

Step 206: It is judged whether the message returned in Step 204 or 205 is an operation success message, and if so, the process proceeds to Step 207; otherwise, the process proceeds to Step 208, which processes the failure of BoD service setup.

Step 207: The source UNI-N initiates a client layer service bandwidth modification procedure. The client layer signaling is sent directly from the source UNI-N to the destination UNI-N. The appropriate VC12 tunnels are configured in the VCG in the source and destination nodes of the tunnel to modify the number of VC12 tunnels in the VCG so as to satisfy the modified bandwidth requirement of the BoD service. For example, if the bandwidth modification value indicates addition of 100 Mbps, 50 VC12 tunnels are configured in the VCG; if the bandwidth modification value indicates addition of 300 Mbps, 150 VC12 tunnels are configured in the VCG; if the bandwidth modification value indicates reduction of 100 Mbps, 50 VC tunnels are deleted from the VCG; if the bandwidth modification value indicates reduction of 300 Mbps, 150 VC tunnels are deleted from the VCG. The bandwidth modification signaling procedure in this scenario is shown in FIG. 3, including:

(a) Upon reception of an Ethernet service bandwidth modification request from the client layer via the UNI interface, the source UNI-N initiates a signaling procedure at the Ethernet client layer directly to modify the bandwidth. The destination UNI-N returns a client layer modification success or failure message to the source UNI-N. If the modification succeeds, the process proceeds to Step (b); otherwise, the process proceeds to Step 208 to process the failure of BoD service setup. The signaling procedure is shown in steps 2, 3, 4, 5, and 6 in FIG. 3.

(b) Send a command to the Ethernet card from the source and destination nodes of the lower layer tunnel to increase or decrease the number of low-order VCs in the VCG of the Ethernet service according to the modified bandwidth, as shown in steps 2a and 3a in FIG. 3.

Step 209: The bandwidth of the BoD service is modified successfully.

It should be noted that, in the foregoing BoD service bandwidth modification procedure, LCAS of the BoD service is enabled before the BoD service is set up. In practice, for bandwidth modification in a BoD service, it is only necessary to enable LCAS of the BoD service before the bandwidth modification. Because LCAS is adopted in the bandwidth modification procedure, the service will not be interrupted during the modification, which means dynamic non-disruptive bandwidth modification.

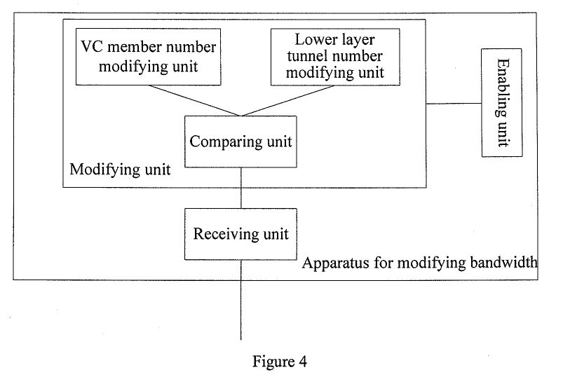

FIG. 4 shows an apparatus for dynamic bandwidth modification in a BoD service according to an embodiment of the present invention. The apparatus includes: an enabling unit, adapted to enable the LCAS function of a BoD service; a receiving unit, adapted to receive a bandwidth modification message sent from a UNI-C to a UNI-N via the control plane, the bandwidth modification message carrying a bandwidth modification value; an modifying unit, adapted to modify the bandwidth according to the bandwidth modification value and the lower layer tunnel granularity. The modifying unit further includes: a comparing unit, adapted to compare the absolute bandwidth modification value with the lower layer tunnel granularity and initiate a VC member number modifying unit if the absolute bandwidth modification value is smaller than the lower layer tunnel granularity, or else initiate the VC member number modifying unit and a lower layer tunnel number modifying unit; the VC member number modifying unit, adapted to modify the number of VC members in the VCG; and the lower layer tunnel number modifying unit, adapted to modify the number of lower layer tunnels. For the working principle of the modifying unit, refer to the bandwidth modification procedure of a BoD service in an Ethernet.

Embodiments of the invention are also applicable to Time Division Multiplex (TDM) circuit networks.

According to embodiments of the invention, the GMPLS technology on the control plane and the LCAS, VC and GFP technologies on the transport platform work together to implement the setup of a BoD service and the non-disruptive modification of service bandwidth. In addition, in the procedure of service bandwidth modification, lower layer tunnels are set up or deleted and the number of VCs in the VCG is increased or decreased to achieve bandwidth modification with a VC12 granularity without consuming low-order cross-connect resources of the equipment.

Although the technical scheme of the present invention has been described through exemplary embodiments, the invention is not limited to such embodiments. It is apparent that those skilled in the art can make various modifications and variations to the invention without departing from the scope of the invention. The invention is intended to cover the modifications and variations provided that they fall in the scope of protection defined by the claims or their equivalents.

What is claimed is:

1. A method for modifying bandwidth in a Bandwidth on Demand (BoD) service, comprising:
receiving, by a User Network Interface (UNI) network (UNI-N), a BoD service based bandwidth modification message from a UNI client (UNI-C) via control plane signaling, the bandwidth modification message carrying a bandwidth modification value; and
modifying, by the UNI-N, a bandwidth according to the bandwidth modification value and a lower layer tunnel granularity.

2. The method of claim 1, wherein the BoD service corresponds to a Virtual Concatenation Group (VCG).

3. The method of claim 2, wherein the step of modifying the bandwidth according to the bandwidth modification value and the lower layer tunnel granularity comprises:
modifying, by the UNI-N, the number of Virtual Concatenation (VC) members in the VCG when an absolute value of the bandwidth modification value is smaller than the lower layer tunnel granularity; or
modifying, by the UNI-N, the number of lower layer tunnels and the number of VC members in the VCG when an absolute value of the bandwidth modification value is larger than or equal to the lower layer tunnel granularity.

4. The method of claim 3, wherein the step of modifying the number of VC members in the VCG comprises:
increasing, by the UNI-N, the number of VC members in the VCG according to the bandwidth modification value when the bandwidth modification value indicates an addition of bandwidth; or
reducing, by the UNI-N, a number of VC members in the VCG according to the bandwidth modification value when the bandwidth modification value indicates a reduction of bandwidth.

5. The method of claim 3, wherein the step of modifying the number of lower layer tunnels comprises:
setting up, by the UNI-N, lower layer tunnels according to the bandwidth modification value when the bandwidth modification value indicates an addition of bandwidth; or
deleting, by the UNI-N, lower layer tunnels according to the bandwidth modification value when the bandwidth modification value indicates a reduction of bandwidth.

6. The method of claim 1, further comprising:
setting up, by the UNI-N, the BoD service before the UNI-N receives the bandwidth modification message from the UNI-C via control plane signaling.

7. The method of claim 6, wherein the step of setting up the BoD service comprises:
assigning, by the UNI-N, a Virtual Concatenation Group (VCG) to the BoD service;
enabling, by the UNI-N, Link Capacity Adjustment Scheme (LCAS) for the VCG;
setting up, by the UNI-N, a lower layer tunnel; and
configuring, by the UNI-N, VC members to the VCG at a source and a destination node of the lower layer tunnel.

8. The method of claim 7, wherein the step of setting up the lower layer tunnel comprises:
initiating, by the UNI-C, a BoD service request, which carries a required bandwidth value by the BoD service; and
setting up, by the UNI-N, the lower layer tunnel according to the required bandwidth value via a control plane.

9. The method of claim 2, further comprising:
enabling, by the UNI-N, Link Capacity Adjustment Scheme (LCAS) for the VCG before the UNI-N receives the bandwidth modification message from the UNI-C via control plane signaling.

10. An apparatus for modifying bandwidth in a Bandwidth on Demand (BoD) service, located in a User Network Interface (UNI) network (UNI-N), comprising:
a receiving unit;
and a modifying unit,
wherein the receiving unit is adapted to receive a BoD service based bandwidth modification message from a UNI client (UNI-C) via control plane signaling, the bandwidth modification message having a bandwidth modification value; and
the modifying unit is adapted to modify bandwidth according to the bandwidth modification value and a lower layer tunnel granularity.

11. The apparatus of claim 10, wherein the BoD service corresponds to a Virtual Concatenation Group (VCG), further comprising:
an enabling unit, adapted to enable a Link Capacity Adjustment Scheme (LCAS) for the VCG.

12. The apparatus of claim 10, wherein the BoD service corresponds to a VCG and the modifying unit further comprises:
a comparing unit;
a Virtual Concatenation (VC) member number modifying unit; and
a lower layer tunnel number modifying unit,
wherein
the comparing unit is adapted to compare an absolute value of the bandwidth modification value with the lower layer tunnel granularity and initiate the VC member number modifying unit when the absolute value of the bandwidth modification value is smaller than the lower layer tunnel granularity; or initiate the VC member number modifying unit and the lower layer tunnel number modifying unit;
the VC member number modifying unit is adapted to modify a number of VC members in the VCG; and
the lower layer tunnel number modifying unit is adapted to modify a number of lower layer tunnels.

13. The apparatus of claim 11, wherein the BoD service corresponds to a VCG and the modifying unit further comprises:
a comparing unit, a Virtual Concatenation (VC) member number modifying unit; and
a lower layer tunnel number modifying unit,
wherein the comparing unit is adapted to compare an absolute value of the bandwidth modification value with the lower layer tunnel granularity and initiate the VC member number modifying unit when the absolute value of the bandwidth modification value is smaller than the lower layer tunnel granularity; or initiate the VC member number modifying unit and the lower layer tunnel number modifying unit;
the VC member number modifying unit is adapted to modify a number of VC members in the VCG; and,
the lower layer tunnel number modifying unit is adapted to modify a number of lower layer tunnels.

14. A computer program product, stored on a computer readable media, having computer executable instructions configuring a computer to perform a method for modifying bandwidth in a Bandwidth on Demand (BoD) service, comprising:
receiving, by a User Network Interface (UNI) network (UNI-N), a BoD service based bandwidth modification message from a UNI client (UNI-C) via control plane signaling, the bandwidth modification message carrying a bandwidth modification value; and
modifying, by the UNI-N, a bandwidth according to the bandwidth modification value and a lower layer tunnel granularity.
